(19) United States
(12) Patent Application Publication
(10) Pub. No.: US 2015/0321399 A1
(43) Pub. Date: Nov. 12, 2015

(54) COMPONENT FOR MANUFACTURING APPAREL ACCESSORY OR FASTENING ELEMENT, METHOD OF MANUFACTURING SAID APPAREL ACCESSORY OR SAID FASTENING ELEMENT MADE OF SAID COMPONENT, AND MOLDED PRODUCT MADE OF SAID COMPONENT

(71) Applicants: Chia-Wei HONG, New Taipei City (TW); GUO YE INDUSTRIAL CO., LTD., New Taipei City (TW)

(72) Inventors: Chia-Wei HONG, New Taipei City (TW); Chia-Hong LIAO, New Taipei City (TW)

(21) Appl. No.: 14/337,879

(22) Filed: Jul. 22, 2014

(30) Foreign Application Priority Data
May 6, 2014 (TW) 103116125

(51) Int. Cl. B29C 45/14; C08K 5/00; C08L 75/04; A44B 19/26; C08L 67/03; A44B 1/02; A44B 1/04; A44B 11/00; C08K 3/00; C08L 21/00

(52) U.S. Cl. CPC B29C 45/14336; C08K 3/0033; C08K 5/0041; C08L 75/04; C08L 21/00; C08L 67/03; A44B 1/02; A44B 1/04; A44B 11/001; A44B 19/262; B29K 2021/003

(57) ABSTRACT

A component for manufacturing an apparel accessory or a fastening element is formed of a molten thermoplastic polymer and an additive distributed into the molten thermoplastic polymer. A method of manufacturing said apparel accessory or said fastening element made of said component includes a step of fixedly molding the component of the present invention to a base of an accessory. A molded product made of said component is well decorative and highly durable.

### BACKGROUND OF THE INVENTION

1. Field of the Invention

The present invention relates generally to an apparel accessory or a fastening element and more particularly, to a component for manufacturing an apparel accessory or a fastening element, a method of manufacturing said apparel accessory or said fastening element made of said component, and a molded product made of said component.

2. Description of the Related Art

As the fashion trend evolves, some apparel accessories, such as zippers or buttons, have transformed into decorative items from function ones. For example, a conventional zipper is structurally formed of two opposite toothed tapes, a slider for meshing or separating the two toothed tapes, and a pull tab for a user to operate it to move the slider. To enhance the operational convenience and perception of design quality, a through hole is usually formed at a distal end of the pull tab and then a knitted strap having a pattern or color is inserted through the hole to be fixed to the pull tab.

### SUMMARY OF THE INVENTION

The primary objective of the present invention is to provide a component for manufacturing an apparel accessory or a fastening element.

The foregoing objective of the present invention is attained by the component formed of a molten thermoplastic polymer and an additive distributed into the molten thermoplastic polymer. The additive includes a plurality of color particles having a variety of colors.

In the component, the molten thermoplastic polymer is one or multiple polymers selected from a group consisting of polyurethane (PU), thermoplastic elastomer (TPE), and thermoplastic rubber (TPR).

In the component, each of color particles is preferably 0.2-3 mm in diameter.

In a preferred embodiment, each of the color particles includes a main body and an electroplated layer covering the main body. The main body is made of polyethylene terephthalate (PET) preferably.

The secondary objective of the present invention is to provide a method of manufacturing the apparel accessory or the fastening element made of the component. The method includes the step of fixedly molding the component of the present invention to a base of an accessory. In the method, the component is fixed to the base of the accessory by injection molding.

In a preferred embodiment, the method further includes a step of processing the component by injection molding.

Another objective of the present invention is to provide the apparel accessory or the fastening element manufactured by the method. The apparel accessory or the fastening element is well decorative and highly durable as a whole.

### BRIEF DESCRIPTION OF THE DRAWINGS

FIG. 1 is a perspective view of a zipper slider manufactured in accordance with a method of a first preferred embodiment of the present invention.

FIG. 2 is a perspective view of a button manufactured in accordance with the method of the first preferred embodiment of the present invention.

FIG. 3 is a perspective view of a fastening element manufactured in accordance with a method of a second preferred embodiment of the present invention.

FIG. 4 is a perspective view of a zipper extended member the second preferred embodiment of the present invention.

### DETAILED DESCRIPTION OF PREFERRED EMBODIMENTS

Structural features and desired effects of the present invention will become more fully understood by reference to preferred embodiments given hereunder. However, it is to be understood that these embodiments are given by way of illustration only, thus being not limitative of the claim scope of the present invention.

According to a preferred embodiment of the present invention, a component for manufacturing an apparel accessory or a fastening element is formed of a molten thermoplastic polymer and an additive distributed into the molten thermoplastic polymer. In addition, the additive includes a plurality of color particles having a variety of colors. The ingredients of the component of this preferred embodiment of the present invention are recited in the following paragraphs.

First, the thermoplastic polymer can be either of various common thermoplastic polymers in the relevant technical field without any limitation as long as the thermoplastic polymer keeps molten.

Further, the thermoplastic polymer can be one or multiple polymers selected from a group consisting of PU, TPE, and TPR. However, if environmental protection is taken into account, the thermoplastic polymer is PU preferably.

The numerous color particles of the additive includes a variety of colors for the purpose of making the product manufactured based on the component decorative. In addition, the color particles are not limited to any shape and can be laminated, spherical, or irregular. In addition, if the molten thermoplastic polymer is 100 by weight, the additive will preferably be 0.1 by weight. In other words, considering the decorative effective of the additive, the additive can be selectively controlled within the range of 0.1 to 100 by weight. Each of the color particles is preferably 0.2-3 mm in diameter.

Each of the color particles includes a main body and an electroplated layer covering the main body. The main body is made of polyethylene terephthalate (PET). For example, the color particles can be coated under high temperature by PET to which a vacuum electroplating is applied.

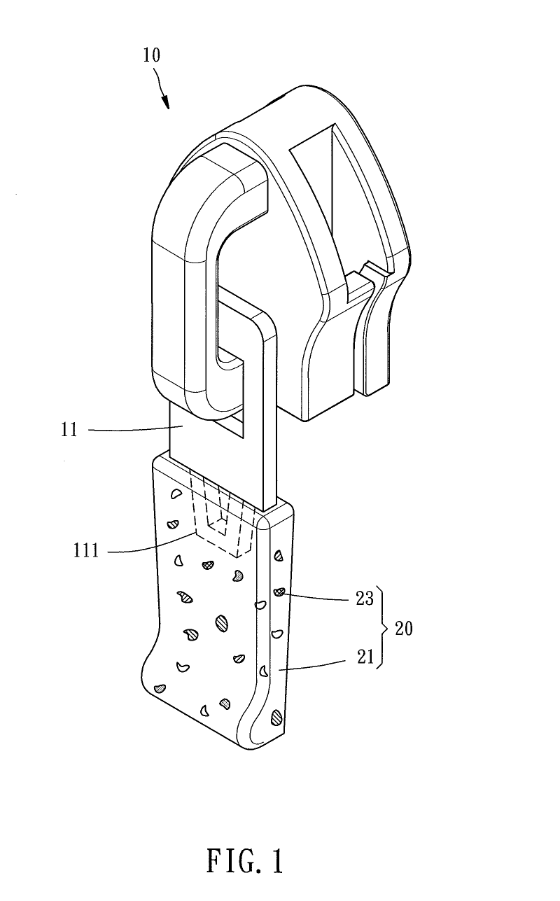

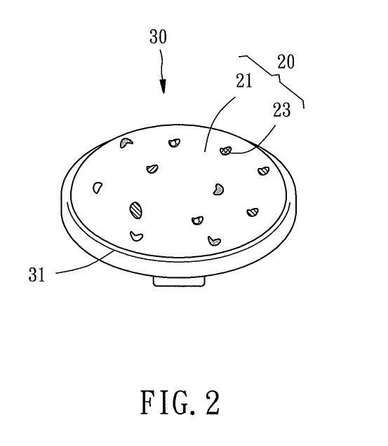

A method of manufacturing the apparel accessory or the fastening element made of the aforesaid component in accordance with a preferred embodiment includes a step of fixedly molding the component to a base of an accessory. The way to fixedly mold the component to the base of the accessory is preferably but not limited to injection molding. For example, referring to FIG. 1, the component of the present invention can be fixedly to a distal end of a pull tab 11 by injection molding and thereby a zipper slider 10 can be produced. The pull tab 11 is the aforesaid base of the accessory and can have a linking portion 111 protruding outward from the distal end thereof. The component 20 having the thermoplastic polymer 21 and the additive 23 can be fixedly molded to the linking portion 111 to make the pull tab 111 and the molded component 20 shaped in one piece. Referring to FIG. 2, the component 20 having the thermoplastic polymer 21 and the additive 23 can also be fixed to a pedestal 31 of a button 30 by injection molding, and the pedestal 31 is the aforesaid base of the accessory.

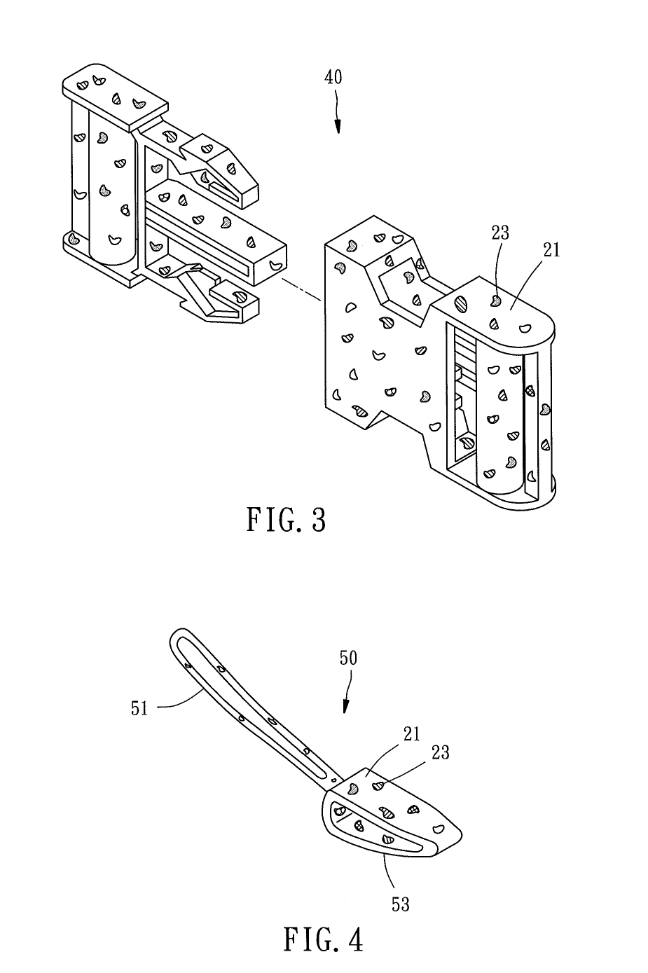

The method of manufacturing the apparel accessory or the fastening element made of the aforesaid component in accordance with a second preferred embodiment of the present invention includes a step of applying injection molding to the component. For example, referring to FIG. 3, the component can be processed by injection molding to become a buckle 40. In this way, the buckle 40 includes the main body made of the thermoplastic polymer 21 after solidification and the color particles 23 doped into the main body for making the buckle 40 abundantly decorative. Referring to FIG. 4, the component can also be processed by injection molding to become a zipper extended member 50. The zipper extended member 50 is formed of a linking loop 51 and a handhold piece 53, which are made of the molten thermoplastic polymer 21 and into which the color particles 23 are doped. The zipper extended member 50 can be fixed to a zipper (not shown) after the linking loop 51 is inserted through a through hole located at a distal end of the zipper and then the handhold piece 53 is inserted through the linking loop 51.

In conclusion, the component of the present invention includes the color particles having a variety of colors, so the zipper, the button, the fastening element, or the zipper extended member produced based on the component and the method of the present invention can have high durability and well decorative effect on the apparel.

What is claimed is:

1. A component for manufacturing an apparel accessory or a fastening element, comprising:
a molten thermoplastic polymer; and
an additive distributed into the molten thermoplastic polymer and having a plurality of color particles having a variety of colors.

2. The component as defined in claim 1, wherein the molten thermoplastic polymer is 100 by weight and the additive is 0.1 by weight.

3. The component as defined in claim 1, wherein the molten thermoplastic polymer is one or multiple polymers selected from a group consisting of polyurethane (PU), thermoplastic elastomer (TPE), and thermoplastic rubber (TPR).

4. The component as defined in claim 1, wherein each of the color particles is 0.2-3 mm in diameter.

5. The component as defined in claim 1, wherein each of the color particles comprises a main body and an electroplated layer covering the main body.

6. The component as defined in claim 5, wherein the main body of each color particle is made of polyethylene terephthalate (PET).

7. A method of manufacturing an apparel accessory or a fastening element comprises a step of fixedly molding the component defined in claim 1 to a base of an accessory.

8. The method as defined in claim 7, wherein the component is fixedly molded to the base of the accessory by injection molding.

9. A method of manufacturing an apparel accessory or a fastening element as defined in claim 1, comprise a step of processing the component by injection molding.

10. A molded apparel accessory or a molded fastening element is manufactured by a method defined in claim 7.

11. A molded apparel accessory or a molded fastening element is manufactured by a method defined in claim 8.

12. A molded apparel accessory or a molded fastening element is manufactured by a method defined in claim 9.
